(19) United States
(12) Patent Application Publication
(10) Pub. No.: US 2019/0288247 A1
(43) Pub. Date: Sep. 19, 2019

(54) SEMI-FINISHED PRODUCT FOR CONTACTING COMPONENTS

(71) Applicant: Robert Bosch GmbH, Stuttgart (DE)

(72) Inventors: Irene Jennrich, Kernen-Stetten (DE); Claudia Neumann, Aichwald (DE); Klaus-Volker Schuett, Wernau (DE); Michael Raedler, Hamburg (DE)

(21) Appl. No.: 16/336,182

(22) PCT Filed: Oct. 2, 2017
(86) PCT No.: PCT/EP2017/074975

§ 371 Date: Mar. 25, 2019

(30) Foreign Application Priority Data
Oct. 14, 2016 (DE) 10 2016 220 092.5

(51) Int. Cl. H01M 2/02

(52) U.S. Cl. CPC H01M 2/0285; H01M 2/20; H01M 2/0295

(57) ABSTRACT

A semi-finished product for the, in particular, thermal and/or electrical contacting of components, for example, battery cells and/or electronics components. In order to simplify methods for manufacturing electrical and/or electrochemical and/or electronic assemblies, for example, batteries and/or electronics assemblies, a semi-finished product is provided, which includes at least one epoxy resin based on bisphenol A and/or bisphenol F, at least one filler, and at least one hardener and/or catalyst. A reaction resin system and a manufacturing method are also described.

### FIELD

The present invention relates to a semi-finished product for the, in particular, thermal and/or electrical contacting of electrical and/or electrochemical and/or electronic components, as well as to a reaction resin system and manufacturing methods.

### BACKGROUND INFORMATION

Thermal interface materials (TIM) in the form of plates, foils, pastes, or gels may be utilized for the thermal and/or electrical contacting of components, such as battery cells and electronic components, such as chips. Plate-shaped or foil-shaped thermal interface materials may be fixed, for example, with the aid of a single- or double-sided, self-adhesive coating or with the aid of a single- or double-sided adhesive tape.

In this regard, German Patent Application No. DE 10 2015 208 438 A1 describes a temperature control device for a battery, in which a plate-shaped heat exchanger is provided for the heat transfer from a battery to an appropriate thermal interface medium.

### SUMMARY

The present invention relates to a semi-finished product for the, in particular, thermal and/or electrical contacting of, in particular, electrical and/or electrochemical and/or electronic components, which includes at least one epoxy resin based on bisphenol A and/or bisphenol F, at least one filler, and at least one hardener, or is made thereof.

For example, the semi-finished product may be designed and utilized for the thermal contacting—and, for example, electrical insulation—of battery cells and/or electronic components and/or for the electrical contacting—and, if necessary, also thermal contacting—of electronic components. For example, the semi-finished product may be designed and utilized for the thermal contacting and, for example, electrical insulation of battery cells, and/or for the thermal and electrical contacting of electronic components, for example, of one or multiple electronic chip(s), for example MOSFET, and/or of a circuit substrate, for example, a circuit board and/or printed circuit board (PCB), for example, between one or multiple electronic chips and a circuit substrate, and/or for the thermal contacting and, for example, electrical insulation of electronic components, for example, of one or multiple electronic chip(s), and/or of a circuit substrate, for example, between one or multiple electronic chips and/or a circuit substrate. For example, the semi-finished product may be designed and utilized for manufacturing an electrical and/or electrochemical and/or electronic assembly, for example, a battery and/or an electronics assembly.

Epoxy resins based on bisphenol A and/or bisphenol F are, advantageously, liquid at room temperature and may be cross-linked even at room temperature or at a higher temperature, in particular depending on the utilized hardener. This makes it possible to provide a semi-finished product, for example, having desired dimensions, which is moldable, in particular at room temperature, onto a component to be contacted, for example. In this way, unevenness, such as recesses and/or gaps, formed, for example, by radii, may be advantageously filled with the material of the semi-finished product. In this way, for example, thermal boundary surfaces may be minimized and/or an electrical insulation or contacting may be optimized. Thereafter, the material of the semi-finished product may be advantageously cross-linked and, thereby hardened, for example, in a comparatively short time, for example, at room temperature or at an elevated temperature.

Due to the fact that the semi-finished product may be molded onto the component or components to be contacted and then hardened, a fixation of the semi-finished product to the component or components may also be advantageously implemented with the aid of the semi-finished product. In this way, the utilization of adhesives, such as self-adhesive coatings and/or adhesive tapes, may be advantageously dispensed with. Due to the utilization of the semi-finished product in a method for manufacturing electrical and/or electrochemical and/or electronic assemblies, for example, a battery and/or an electronics assembly, at least one process step may be dispensed with and/or the method may be simplified.

In addition, epoxy resins based on bisphenol A and/or bisphenol F as such are electrically insulating and, therefore, are suitable for applications in which an electrical insulation with the aid of the semi-finished product is desirable, for example, for the heat-conducting and electrically insulating contacting of battery cells.

The processing and functional characteristics of the semi-finished product, such as its thermal conductivity and/or electrical conductivity and/or processability, may be advantageously adjusted with the aid of the at least one filler and the fill level of the at least one filler. In this way, the semi-finished product may advantageously have high thermal conductivity and electrical conductivity.

In addition, a low expansion coefficient of the semi-finished product may be achieved with the aid of the at least one filler. In addition, due to the material composition and the fill level of the at least one filler, material costs for the manufacture of the semi-finished product may be achieved, which are lower than the material costs for manufacturing conventional thermal interface materials and/or thermal pastes or gels.

Overall, in this way, methods for manufacturing electrical and/or electrochemical and/or electronic assemblies, such as a battery and/or an electronics assembly, may be simplified with the aid of the semi-finished product, in particular in a cost-effective way.

Advantageously, the semi-finished product may be prefabricated in nearly arbitrary shapes, for example, as a plate, a pad, or a rod-shaped section. The individual moldability of the semi-finished product to the particular component to be equipped therewith advantageously enables its utilization in a multitude of various products.

Within the scope of one specific embodiment, the semi-finished product is hardenable at a temperature in a range from ≥20° C. to <120° C. For example, the semi-finished product may be hardenable at a temperature in a range from ≥20° C. to ≤100° C. or ≤80° C., in particular at a temperature in a range from ≥20° C. to ≤60° C. The thermal load of the components to be contacted with the semi-finished product, for example, battery cells, may be advantageously limited in this way.

Within the scope of one further specific embodiment, the at least one hardener includes an amine hardener and/or an (acid) anhydride hardener and/or a catalyst, or is made thereof. Hardener components based on amine and/or acid anhydride have proven particularly advantageous for incorporating fillers. Amine hardeners, such as polyamines and/or polyaminoamides, may advantageously enable a cold-warm cross-linking and may even cross-link, for example, at a temperature of ≤60° C., for example, at room temperature. Anhydride hardeners and/or catalysts may be utilized, for example, for a, for example, cold-hot cross-linking at higher temperatures.

Within the scope of one further specific embodiment, the at least one filler encompasses at least one heat-conducting filler and/or at least one electrically conductive filler, in particular, at least one heat-conducting filler. In this way, the semi-finished product may be advantageously provided with heat-conducting and/or electrically insulating or conductive properties.

For example, the at least one, in particular, heat-conducting and, if necessary, electrically insulating or conductive, filler may include or be aluminum hydroxide and/or aluminum oxide and/or silicon dioxide, in particular quartz, and/or boron nitride and/or aluminosilicate and/or aluminum nitride and/or magnesium oxide and/or magnesium carbonate and/or silver and/or silicon and/or chalk and/or microdolomite and/or talc and/or mica and/or carbon black and/or graphite and/or graphene.

Due to the utilization of aluminum hydroxide, aluminum oxide, silicon dioxide, in particular quartz, boron nitride, aluminosilicate, aluminum nitride, magnesium oxide, magnesium carbonate, chalk, microdolomite, talc and/or mica, a material having heat-conducting and electrically insulating properties may be provided, for example, for the heat-conducting and electrically insulating contacting of battery cells, for example, for manufacturing a battery.

Due to the utilization of silver, silicon, carbon black, graphite and/or graphene, a material having heat-conducting and electrically insulating properties may be provided, for example, for the heat-conducting and electrical contacting of electronic components, for example, for manufacturing an electronics assembly.

Within the scope of an example embodiment of the present invention, the at least one filler includes or is aluminum hydroxide and/or aluminum oxide and/or silicon dioxide, in particular quartz, and/or boron nitride. In particular, the at least one filler may include or be aluminum hydroxide and/or aluminum oxide and/or silicon dioxide, in particular quartz.

For example, the at least one filler may have a particle size distribution in a range from ≥2 μm to ≤1 mm. Nanoparticles may also be contained in the mixture, if necessary.

Within the scope of a further specific embodiment, the semi-finished product may also encompass at least one silicon or polyorganosiloxane.

For example, the semi-finished product may encompass the at least one silicon in the form of a formulation based on bisphenol A epoxy and/or bisphenol F epoxy, in particular bisphenol A epoxy, including silicon elastomer particles.

In the formulation, epoxy units, in particular, may be chemically, for example, covalently, bonded with silicon units, in particular those which form the silicon elastomer particles. For example, epoxy units may be chemically bonded with silicon elastomer particles, for example, grafted thereon, or polymer sequences including non-polar silicon units may tangle up to form silicon elastomer particles, polymer sequences including polar epoxy units being turned outwardly. Therefore, the formulation may encompass or be made of, in particular, elastic particles or silicon elastomer particles, the interior of which is formed from silicon units and the exterior of which is formed from epoxy units.

Due to the silicon elastomer particles, in particular the silicon units, in the interior of the particles, the modulus of elasticity of the hardened semi-finished product may be advantageously reduced. This has the advantage, in turn, that the hardened semi-finished product may also absorb high tensile and compressive forces and high deformation forces, for example, of battery cells, for example, during charging/discharging processes of the battery cells, in particular throughout the entire service life. In addition, due to the silicon elastomer particles, in particular the silicon units in the interior of the particles, the fracture toughness (toughness modification) may be advantageously increased and a, for example, progressive cracking may be avoided. As a result, also advantageously, the abrasion resistance may therefore be improved. Due to the, in particular, chemically bonded epoxy units, in particular those which form the exterior of the particles, the particles may additionally behave chemically in the manner of an epoxy, for example, in an epoxy resin matrix.

The formulation may be utilized, for example, in the form of a dispersion of resin and silicon elastomer particles, for example, cross-linked polyorganosiloxane particles. For example, the formulation may be utilized in the form of a dispersion which contains the at least one epoxy resin based on bisphenol A and/or bisphenol F, in particular bisphenol A, and, in particular, solid or liquid silicon elastomer particles. In this case, the silicon may be contained in the dispersion, for example, having been cross-linked to form a rubbery elastic polymer.

In addition, the semi-finished product may also encompass at least one additive, for example, at least one defoamer, for example, based on silicon, and/or at least one wetting and dispersing agent, for example, a copolymer including acidic groups, such as phosphoric acid groups.

Within the scope of one specific embodiment of the present invention, the semi-finished product encompasses
≥4 weight percent to ≤10 weight percent, in particular 4 weight percent to <9 weight percent, of the at least one epoxy resin based on bisphenol A and/or bisphenol F, and/or
≥70 weight percent to ≤90 weight percent, in particular ≥80 weight percent to ≤90 weight percent, of the at least one filler, and/or
≥3 weight percent to ≤12 weight percent of the at least one hardener and/or catalyst, in particular hardener, and/or
≥0.5 weight percent to ≤3 weight percent of the at least one silicon or polyorganosiloxane, and/or
≥0.1 weight percent to ≤1 weight percent of the at least one or at least one additive.

It has been found, advantageously, that even such a small portion of the at least one epoxy resin based on bisphenol A and/or bisphenol F suffices for manufacturing a semi-finished product which is moldable, in particular, at room temperature.

Due to such a portion of the formulation based on bisphenol A epoxy and/or bisphenol F epoxy, in particular bisphenol A epoxy, including silicon elastomer particles, the processing and functional characteristics of the semi-finished product may be improved.

The material of the semi-finished product may be partially cross-linked, if necessary. For example, the semi-finished product may be made of a B stage material.

In principle, the semi-finished product may be designed in or may have nearly any arbitrary shape.

Within the scope of a special specific embodiment, the semi-finished product is a plate, a pad, or a foil, or is rod-shaped.

For example, the semi-finished product may be a heat-conducting and electrically insulating plate, a heat-conducting and electrically insulating pad, or a heat-conducting and electrically insulating foil, for example, for the heat-conducting contacting and electrical insulation of battery cells and/or electronic components.

The semi-finished product may also be, for example, a heat-conducting and electrically conductive plate, a heat-conducting and electrically conductive pad, or a heat-conducting and electrically conductive foil, for example, for the heat-conducting and electrically conductive contacting of electronic components.

Within the scope of one further specific embodiment, the semi-finished product encompasses or is made of a reaction resin system according to the present invention, which is explained in the following.

For example, the semi-finished product may be manufactured with the aid of a method explained below, or may be utilized therein.

With respect to further technical features and advantages of the semi-finished product according to the present invention, reference is hereby explicitly made to the explanations in conjunction with the reaction resin system according to the present invention and to the methods according to the present invention, and to the figures and the description of the figures.

A further subject matter of the present invention is a reaction resin system, in particular for manufacturing a semi-finished product according to the present invention and/or for the, in particular, thermal and/or electrical contacting of electrical and/or electrochemical and/or electronic components.

For example, the reaction resin system may be designed and utilized for the thermal contacting—and, for example, electrical insulation—of battery cells and/or electronics components and/or for the electrical contacting—and, if necessary, also thermal contacting—of electronics components. For example, the reaction resin system may be designed and utilized for the thermal contacting and, for example, electrical insulation of battery cells, and/or for the thermal and electrical contacting of electronics components, for example, of one or multiple electronic chip(s), for example MOSFET, and/or of a circuit substrate, for example, between one or multiple electronic chip(s) and a circuit substrate, and/or for the thermal contacting and, for example, electrical insulation of electronics components, for example, of one or multiple electronic chip(s), and/or of a circuit substrate, for example, between one or multiple electronic chip(s) and/or a circuit substrate. For example, the reaction resin system may be designed and utilized for manufacturing an electrical and/or electrochemical and/or electronic assembly, for example, a battery and/or an electronics assembly. In particular, the reaction resin system may be utilized in a method explained in the following.

The reaction resin system encompasses, in particular, at least one epoxy resin based on bisphenol A and/or bisphenol F and at least one filler. Moreover, the reaction resin system may encompass, in particular, at least one hardener and/or catalyst, in particular a hardener. In particular, the reaction resin system may encompass at least one epoxy resin based on bisphenol A and/or bisphenol F, at least one filler, and at least one hardener and/or catalyst, in particular a hardener.

In addition, the reaction resin system may also encompass, for example, at least one silicon or polyorganosiloxane, for example, in the form of a formulation based on bisphenol A epoxy and/or bisphenol F epoxy, in particular bisphenol A epoxy, including silicon elastomer particles.

Moreover, the reaction resin system may also encompass, for example, at least one additive, for example, at least one defoamer, for example, based on silicon, and/or at least one wetting and dispersing agent, for example, a copolymer including acidic groups, such as phosphoric acid groups.

For example, the reaction resin system may encompass
≥4 weight percent to ≤10 weight percent, in particular ≥4 weight percent to <9 weight percent, of the at least one epoxy resin based on bisphenol A and/or bisphenol F, and/or
≥70 weight percent to ≤90 weight percent, in particular ≥80 weight percent to ≤90 weight percent, of the at least one filler, and/or
≥3 weight percent to ≤12 weight percent of the at least one hardener and/or catalyst, in particular hardener, and/or
≥0.5 weight percent to ≤3 weight percent of the at least one silicon or polyorganosiloxane, and/or
≥0.1 weight percent to ≤1 weight percent of the at least one or at least one additive.

Within the scope of a specific embodiment of the present invention, the reaction resin system encompasses
≥4 weight percent to <9 weight percent of at least one epoxy resin based on bisphenol A and/or bisphenol F, and
≥70 weight percent to ≤90 weight percent, in particular ≥80 weight percent to ≤90 weight percent, of the at least one filler.

This has proven particularly advantageous for forming a semi-finished product which is moldable, in particular, at room temperature.

Within the scope of one further specific embodiment of the present invention, the reaction resin system also encompasses ≥0.5 weight percent to <3 weight percent of the or of at least one silicon or polyorganosiloxane. This has proven advantageous with respect to the processing and functional characteristics of the reaction resin system and a semi-finished product made thereof.

The reaction resin system may be hardenable, in particular, at a temperature in a range from ≥20° C. to <120° C. For example, the semi-finished product may be hardenable at a temperature in a range from ≥20° C. to ≤100° C. or ≤80° C., in particular at a temperature in a range from ≥20° C. to ≤60° C.

Within the scope of one further specific embodiment of the present invention, the at least one hardener encompasses an amine hardener and/or an anhydride hardener and/or a catalyst, or is made thereof. For example, the at least one hardener may encompass or be made of an amine hardener and/or an anhydride hardener, in particular an amine hardener, for example, at least one polyamine and/or polyaminoamide.

Within the scope of one further specific embodiment of the present invention, the at least one filler encompasses at least one heat-conducting filler and/or at least one electrically conductive filler, in particular, at least one heat-conducting filler.

For example, the at least one, in particular, heat-conducting filler may encompass or be aluminum hydroxide and/or aluminum oxide and/or aluminum nitride and/or silicon dioxide, in particular quartz, and/or boron nitride and/or aluminosilicate and/or magnesium oxide and/or magnesium carbonate and/or silver and/or silicon and/or chalk and/or microdolomite and/or talc and/or mica and/or carbon black and/or graphite and/or graphene.

Due to the utilization of aluminum hydroxide, aluminum oxide, silicon dioxide, in particular quartz, boron nitride, aluminosilicate, aluminum nitride, magnesium oxide, magnesium carbonate, chalk, microdolomite, talc and/or mica, a material having heat-conducting and electrically insulating properties may be provided, for example, for the heat-conducting and electrically insulating contacting of battery cells, for example, for manufacturing a battery.

Due to the utilization of silver, silicon, carbon black, graphite and/or graphene, a material having heat-conducting and electrically insulating properties may be provided, for example, for the heat-conducting and electrical contacting of electronic components, for example, for manufacturing an electronics assembly.

Within the scope of one special embodiment of the present invention, the at least one filler encompasses or is aluminum hydroxide and/or aluminum oxide and/or silicon dioxide, in particular quartz, and/or boron nitride. In particular, the at least one, in particular, heat-conducting filler may encompass or be aluminum hydroxide and/or aluminum oxide and/or silicon dioxide, in particular quartz.

For example, the at least one filler may have a particle size distribution in a range from ≥2 μm to ≤1 mm. Nanoparticles may also be contained in the mixture, if necessary.

The reaction resin system may be, for example, a one-component system or a two-component system.

Within the scope of one specific embodiment example embodiment, the reaction resin system is a two-component system. In this case, the first component, in particular, may contain the at least one epoxy resin based on bisphenol A and/or bisphenol F, and the at least one filler and the second component may contain the at least one hardener and/or catalyst. In this way, storage at sub-zero temperatures may be advantageously dispensed with.

In particular, both the first component as well as the second component may contain the at least one filler in this case. In this way, advantageously, higher fill levels may be implemented and/or more similar viscosities of the components may be achieved, whereby a mixing process of the components may be simplified.

The reaction resin system may be partially cross-linked, if necessary. For example, the reaction resin system may be made of a B stage material.

With respect to further technical features and advantages of the reaction resin system according to the present invention, reference is hereby explicitly made to the explanations in conjunction with the semi-finished product according to the present invention and to the methods according to the present invention, and to the figures and the description of the figures.

In addition, the present invention relates to a method for manufacturing a reaction resin system according to the present invention and/or for manufacturing a semi-finished product according to the present invention.

In the method, for example, in a method step a), in particular, at least one epoxy resin based on bisphenol A and/or bisphenol F and at least one filler may be mixed. In particular, in the method, at least one epoxy resin based on bisphenol A and/or bisphenol F, at least one filler, and at least one hardener and/or catalyst, in particular a hardener, may be mixed.

In this case, for example, the at least one filler and the at least one epoxy resin based on bisphenol A and/or bisphenol F may be pre-mixed, the at least one hardener and/or catalyst may be added, and the mixture may then be further filled with the at least one filler, or the at least one filler, the at least one epoxy resin based on bisphenol A and/or bisphenol F, and the at least one hardener and/or catalyst may be, for example, mixed together, in particular directly. For example, the at least one filler including the at least one epoxy resin based on bisphenol A and/or bisphenol F may be pre-mixed, for example, until a highly viscous state has been reached, for example, in a dissolver, and, after addition of the at least one hardener and/or catalyst, for example, in a roller mill, may be further filled with the at least one filler to the desired fill level, or the at least one filler, the at least one epoxy resin based on bisphenol A and/or bisphenol F, and the at least one hardener and/or catalyst may be mixed, preferably entirely, for example, on a kneader or extruder.

Due to the mixing, in particular, a mixture in the form of a dough-like mass may be formed.

Within the scope of one specific example embodiment, however, initially the at least one epoxy resin based on bisphenol A and/or bisphenol F is mixed with the at least one filler and, for example, a first component of a two-component system is formed. The at least one hardener and/or catalyst, in particular hardener, may form, in particular, a second component of a two-component system in this case. In this case, the at least one hardener and/or catalyst may, for example, be likewise initially mixed with the at least one filler and, for example, form a or the second component of a or the two-component system. In this way, advantageously, higher fill levels may be implemented and/or more similar viscosities of the components may be achieved, whereby a mixing process of the components may be simplified.

In the method, for example, in a method step b), a semi-finished product may then be formed from the mixture, for example, in a shape suitable for the particular application. In this case, the mixture, in particular in the form of a dough-like mass, may be processed, for example, in a roller mill, into a plate, a pad, or a foil, in particular having a desired thickness or, for example, in an extruder, into another, in particular nearly arbitrary, shape. If necessary, in a further step, the material may be prefabricated, for example, punched out, with the aid of a suitable tool, for example, in the desired shape and size. In this way, advantageously, geometric requirements may be met in a more flexible manner. Cost advantages may result therefrom as a function of the quantity and/or size, for example, as compared to the utilization of liquid thermal interface materials.

After the mixing and/or shaping, the material of the semi-finished product or the reaction resin system may be transferred into a partially cross-linked state.

The semi-finished product or the, in particular, (pre-)shaped reaction resin system may be stored separated, for example, with the aid of separating elements, such as separating paper, for example, under cooling to sub-zero temperatures, for example, at approximately −40° C., or may be further processed, for example, in an on-line process, in particular directly, for example, in a or the method for manufacturing an electrical and/or electrochemical and/or electronic assembly explained in the following.

Moreover, the present invention namely relates to a method for manufacturing an, in particular, electrical and/or electrochemical and/or electronic assembly, for example, for manufacturing a battery and/or an electronics assembly.

In this method, a semi-finished product and/or reaction resin system according to the present invention and/or a semi-finished product and/or reaction resin system according to the present invention, which has been manufactured in the manner described above, is molded onto at least one, in particular, electrical and/or electrochemical and/or electronic component.

For example, the semi-finished product or reaction resin system may be molded, if necessary, onto one or multiple battery cell(s) or, for example, on the one hand, onto one or multiple electronic chip(s), for example, MOSFET, and/or, for example, on the other hand, onto a circuit substrate.

With respect to further technical features and advantages of the methods according to the present invention, reference is hereby explicitly made to the explanations in conjunction with the semi-finished product according to the present invention and to the reaction resin system according to the present invention, and to the figures and the description of the figures.

### BRIEF DESCRIPTION OF THE DRAWINGS

Further advantages and advantageous embodiments of the subject matter according to the present invention are illustrated in the figures and the exemplary embodiments and are explained in further detail below. It should be noted that the figures and the exemplary embodiments merely have descriptive character and are not intended to restrict the present invention in any way.

FIG. 1 shows schematic cross sections for illustrating the utilization of a plate-shaped specific embodiment of a semi-finished product according to the present invention on the basis of a manufacture of a battery, for example, including a lateral cooling system.

FIG. 2 shows a schematic cross section for illustrating one specific embodiment of a semi-finished product according to the present invention having a shape adapted to the particular specific application.

### DETAILED DESCRIPTION OF EXAMPLE EMBODIMENTS

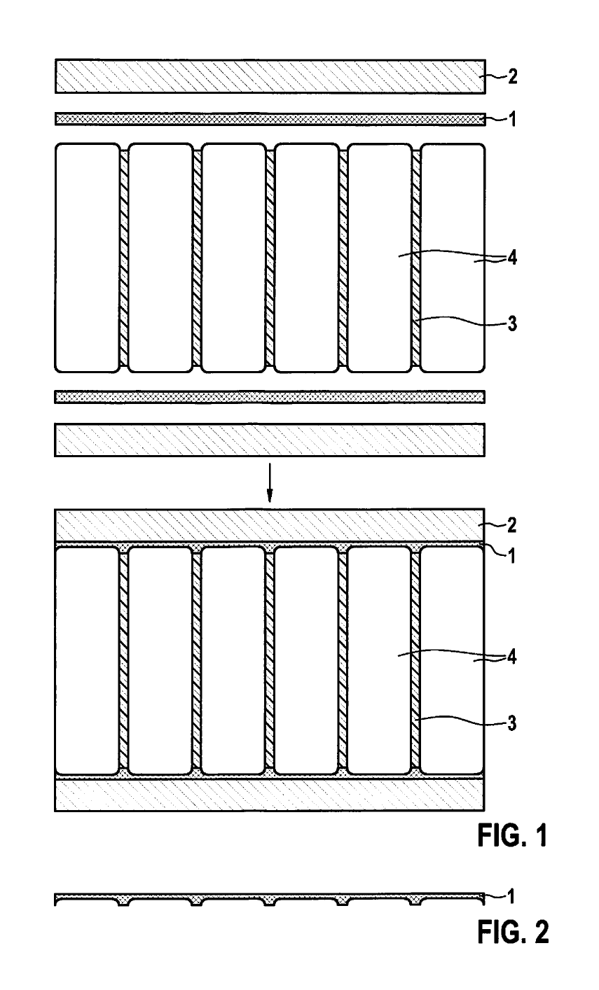

FIG. 1 shows that, to manufacture a battery, a plate-shaped semi-finished product 1 made of an epoxy resin material containing at least one heat-conducting and electrically insulating filler and a plate 2 for fixation during the hardening process, for example, made of aluminum, are situated on a lateral surface of a battery module made of multiple battery cells 4 which have been electrically separated by electrically insulating elements 3, for example, insulating paper. Fixing plates 2 are then pressed in the direction of the lateral surfaces, semi-finished products 1 being molded, on the one hand, to battery cells 4 and, on the other hand, to particular fixing plate 2. In the process, the material of the semi-finished product advantageously penetrates unevenness—forming, for example, due to radii at the cell edges—such as recesses and/or gaps, and fills these. Thereafter, the material of semi-finished products 1 is cross-linked and, thereby hardened.

Due to semi-finished products 1, a thermal connection of battery cells 4 and an electrical insulation between battery cells 4, with respect to one another, may be implemented. In this case, molded and hardened semi-finished products 1 may be additionally utilized—in particular, to a certain extent—for fixation between battery cells 4 with respect to one another. The utilization of such semi-finished products 1 also has the advantage that the material, after cross-linking and hardening, may no longer be squeezed out and, therefore, an electrical insulation and thermal connection may be ensured throughout the service life.

FIG. 2 illustrates that, due to the arbitrary moldability of the material of semi-finished product 1 or of the reaction resin system according to the present invention, in particular in the non-cross-linked state, semi-finished products may be implemented in highly diverse shapes adapted to the particular specific application. A shape of semi-finished product 1, which is possible for the specific application represented in FIG. 1, is represented by way of example in FIG. 2. It is apparent from a synopsis of FIGS. 1 and 2 that, due to the utilization of a semi-finished product 1 having a shape represented in FIG. 2 and adapted to the specific application represented in FIG. 1, the intermediate spaces between adjacent battery cells 4 forming due to radii at the cell edges are sufficiently filled and, advantageously, very small layer thicknesses over the lateral cell walls of battery cells 4 may be achieved, which may advantageously affect the heat dissipation of battery cells 4.

Reaction resin systems having the compositions described in Tables 1 and 2 were manufactured.

TABLE 1
Examples 1 through 5: Reaction resin systems including
amine hardeners

| Example | 1 | 2 | 3 | 4 | 5 |
|---|---|---|---|---|---|
| Bisphenol A/F | 8.6 | 9.4 | 10 | 7 | 8 |
| Silicon | 3.4 | 2.1 | 0.8 | 2.7 | 0.7 |
| Additive | 0.6 | 0.6 | 0.6 | 0.5 | 0.45 |
| Filler 1 | 34.7 | 34.5 | 32.3 | | |
| Filler 2 | 47.9 | 48.2 | 50.6 | | |
| Filler 3 | | | | 85.9 | 86.25 |
| Amine hardener | 4.8 | 5.2 | 5.7 | 3.9 | 4.6 |

TABLE 2
Examples 6 through 13: Reaction resin systems
including anhydride hardeners

| Example | 6 | 7 | 8 | 9 | 10 | 11 | 12 | 13 |
|---|---|---|---|---|---|---|---|---|
| Bisphenol A/F | 5 | 5.6 | 7.25 | 8.2 | 4.18 | 4.58 | 6 | 6.62 |
| Silicon | 3.3 | 0.85 | 3.42 | 0.85 | 2.78 | 0.69 | 2.8 | 0.69 |
| Additive | 0.3 | 0.25 | 0.3 | 0.23 | 0.25 | 0.19 | 0.2 | 0.19 |
| Filler 1 | 35 | 32 | 34.7 | 32.33 | | | | |
| Filler 2 | 48 | 51 | 47.9 | 50.65 | | | | |
| Filler 3 | | | | | 85.83 | 86.24 | 85.7 | 86.24 |
| Anhydride | 8.4 | 10.3 | 6.43 | 7.74 | 6.96 | 8.3 | 5.3 | 6.26 |
| hardener | | | | | | | | |

Filler 1: Aluminum hydroxide including grading curve: D10=3 μm, D50=20 μm, and D90=50 μm.
Filler 2: Silica sand having D50 of 0.18 to 0.25 mm
Filler 3: Aluminum hydroxide including grading curve: D10=0.5 μm, D50=8 μm, and D80=50 μm
Additive: Defoamer based on silicon and a wetting and dispersing additive copolymer including phosphoric acid groups

Plate-shaped semi-finished products were manufactured from the reaction resin systems according to Examples 1 through 13 and were installed in battery systems of the type illustrated in FIG. 1. The electrical insulation of the battery system manufactured in this way was flawless.

The glass transition temperature, the thermal expansion coefficient up to 20° C., the thermal expansion coefficient from 60° C. to 120° C., the breaking stress, the breaking elongation, and the thermal conductivity were determined at room temperature for Examples 1, 3, 4, and 5. The results are presented in Table 3.

TABLE 3
Glass transition temperature, expansion coefficients,
breaking stress and breaking elongation, and thermal
conductivity of Examples 1, 3, 4, and 5

| Example | 1 | 3 | 4 | 5 |
|---|---|---|---|---|
| Glass transition | 38 | 35 | 36 | 37 |
| temperature [° C.] | | | | |
| Thermal expansion | 23 | 26 | 25 | 24 |
| coefficient up to 20° C. | | | | |
| [10⁻⁶ 1/° C.] | | | | |
| Thermal expansion | 60 | 66 | 66 | 58 |
| coefficient from 60° C. to | | | | |
| 120° C. [10⁻⁶ 1/° C.] | | | | |
| Modulus of elasticity at | 7850 | 13400 | 14000 | 16200 |
| 25° C. [N/mm²] | | | | |
| Breaking stress [N/mm²] | 37 | 49 | 46 | 43 |
| Brealing elongation [%] | 0.44 | 0.37 | 0.48 | 0.23 |
| Thermal conductivity at | 2.08 | 2.18 | 2.84 | 2.96 |
| room temperature [W/m-K] | | | | |

Examples 1, 3, 4, and 5 have a thermal conductivity of more than 2 W/m-K and comparatively high glass transition temperatures and lower thermal expansion coefficients.

1-15. (canceled)

16. A semi-finished product for the thermal and/or electrical contacting of electrical and/or electrochemical and/or electronic components, the semi-finished product comprising:
at least one epoxy resin based on bisphenol A and/or bisphenol F;
at least one filler; and
at least one hardener and/or catalyst.

17. The semi-finished product as recited in claim 16, wherein the semi-finished product is hardenable at a temperature in a range from ≥20° C. to <120° C.

18. The semi-finished product as recited in claim 16, wherein the semi-finished product is hardenable at a temperature in a range from ≥20° C. to ≤60° C.

19. The semi-finished product as recited in claim 16, wherein the at least one hardener and/or catalyst encompasses an amine hardener and/or an anhydride hardener and/or a catalyst.

20. The semi-finished product as recited in claim 16, wherein the at least one filler encompasses at least one heat-conducting filler and/or at least one electrically conductive filler.

21. The semi-finished product as recited in claim 16,
wherein the semi-finished product includes:
≥4 weight percent to ≤10 weight percent of the at least one epoxy resin based on bisphenol A and/or bisphenol F; and/or
≥70 weight percent to ≤90 weight percent of the at least one filler; and/or
≥3 weight percent to ≤12 weight percent of the at least one hardener and/or catalyst.

22. The semi-finished product as recited in claim 16,
wherein the semi-finished product includes:
≥4 weight percent to ≤9 weight percent of the at least one epoxy resin based on bisphenol A and/or bisphenol F; and/or
≥80 weight percent to ≤90 weight percent of the at least one filler; and/or
≥3 weight percent to ≤12 weight percent of the at least one hardener and/or catalyst.

23. The semi-finished product as recited in claim 16, wherein the semi-finished product also encompasses ≥0.5 weight percent to ≤3 weight percent of at least one silicon.

24. The semi-finished product as recited in claim 16, wherein the semi-finished product is a plate, or a pad, or a foil, or rod-shaped.

25. A reaction resin system for manufacturing a semi-finished product for the thermal and/or electrical contacting of electrical and/or electrochemical and/or electronic components, the reaction resin comprising:
≥4 weight percent to <9 weight percent of at least one epoxy resin based on bisphenol A and/or bisphenol F; and
≥70 weight percent to ≤90 weight percent of at least one filler.

26. The reaction resin system as recited in claim 25,
wherein the reaction resin system also encompasses ≥0.5 weight percent to <3 weight percent of at least one silicon.

27. The reaction resin system as recited in claim 25, wherein the reaction resin system also encompasses at least one hardener and/or catalyst, the at least one hardener and/or catalyst encompassing an amine hardener and/or an anhydride hardener and/or catalyst.

28. The reaction resin system as claimed in claim 25,
wherein the at least one filler encompasses at least one heat-conducting filler and/or at least one electrically conductive filler, and the at least one filler including aluminum hydroxide and/or aluminum oxide and/or silicon dioxide, in particular quartz, and/or boron nitride and/or alumosilicate and/or aluminum nitride and/or magnesium oxide and/or magnesium carbonate and/or silver and/or silicon and/or chalk and/or microdolomite and/or talc and/or mica and/or carbon black and/or graphite and/or graphene.

29. The reaction resin system as recited in claim 25, wherein the reaction resin system is a two-component system, a first component of the two-component system containing the at least one epoxy resin based on bisphenol A and/or bisphenol F and the at least one filler, and a second component of the two-component system containing the at least one hardener and/or catalyst.

30. The reaction resin system as recited in claim 29,
wherein both the first component as well as the second component contain the at least one filler.

31. A method for manufacturing an electrical and/or electrochemical and/or electronic assembly, comprising:
providing a semi-finished product, the semi-finished product including at least one epoxy resin based on bisphenol A and/or bisphenol F, at least one filler, and at least one hardener and/or catalyst; and
molding the semi-finished product onto an electrical and/or electrochemical and/or electronic component.

32. The method as recited in claim 31, wherein the electrical and/or electrochemical and/or electronic assembly is a battery or an electronics assembly.
